(19) United States
(12) Patent Application Publication
(10) Pub. No.: US 2010/0059315 A1
(43) Pub. Date: Mar. 11, 2010

(54) HIGH EFFICIENCY LUBRICATION PUMP

(76) Inventors: Timothy M. BURNS, Elbridge, NY (US); Sankar K. Mohan, Jamesville, NY (US)

Correspondence Address: MAGNA INTERNATIONAL, INC., 337 MAGNA DRIVE, AURORA, ON, L4G-7K1, CA

(21) Appl. No.: 12/557,603

(22) Filed: Sep. 11, 2009

Related U.S. Application Data
(60) Provisional application No. 61/095,963, filed on Sep. 11, 2008.

(51) Int. Cl. F01M 1/12; F16H 59/02; F16H 61/32; F16D 43/21

(52) U.S. Cl. 184/6.1; 74/473.19; 74/473.12; 192/55.1

(57) ABSTRACT

A lubrication and shift system for a power transfer device includes an input shaft, an output shaft driven by the input shaft and a lubrication pumping system, including a pump being driven by the input shaft to provide pressurized fluid to a first fluid path. A first pump control system includes a cover plate being moveable to vary the output of the pump. A second pump control system includes a valve member selectively moveable to open and close a second fluid path. The pump output pressure is reduced when the second fluid path is open. A third pump control system includes a torque-limiting coupling limiting a maximum input torque to the pump.

### CROSS-REFERENCE TO RELATED APPLICATIONS

This application claims the benefit of U.S. Provisional Application No. 61/095,963, filed on Sep. 11, 2008. The entire disclosure of the above application is incorporated herein by reference.

### FIELD

The present invention relates generally to fluid pumps and, more particularly, to a torque limited fluid pump for use in power transmission units of the type installed in motor vehicles.

### BACKGROUND

As is well known, fluid pumps are used in power transmission units of the type installed in motor vehicles for supplying lubricant to the rotary drive components. Such power transmission units typically include manual and automatic transmissions and transaxles, four-wheel drive transfer cases and all-wheel drive power transfer assemblies. In many applications, the lube pump is a gerotor pump having an eccentric outer rotor and an inner rotor that is fixed for rotation with a drive member such as, for example, a drive shaft. The inner rotor has external lobes which are meshed with and eccentrically offset from internal lobes formed on the outer rotor. The rotors are rotatably disposed in a pressure chamber formed in a pump housing that is non-rotationally fixed within the power transmission unit. Rotation of the drive shaft results in the rotors generating a pumping action such that fluid is drawn from a sump in the power transmission unit into a low pressure inlet side of the pressure chamber and is subsequently discharged from a high pressure outlet side of the pressure chamber at an increased fluid pressure. The higher pressure fluid is delivered from the pump outlet through one or more fluid flow passages to specific locations along the driven shaft to lubricate rotary components and/or cool frictional components. One example of a bi-directional gerotor-type lube pump is disclosed in commonly-owned U.S. Pat. No. 6,017,202.

While gerotor pumps have widespread application in lubrication systems, the use of certain designs may result in undesirable compromises in their function and structure. For example, most conventional gerotor pumps are extremely inefficient, and are typically incapable of providing adequate lubricant flow at low rotary speeds while providing too much lubricant flow at high rotary speeds. To remedy such functional drawbacks, it is known to replace the conventional gerotor pump with a more expensive variable displacement lube pump or an electrically-controlled lube pump. Thus, a continuing need exists to develop alternatives to conventional gerotor lube pumps for use in power transmission units.

### SUMMARY

This section provides a general summary of the disclosure, and is not a comprehensive disclosure of its full scope or all of its features.

A lubrication and shift system for a power transfer device includes an input shaft, an output shaft driven by the input shaft and a lubrication pumping system, including a pump being driven by the input shaft to provide pressurized fluid to a first fluid path. A first pump control system includes a cover plate being moveable to vary the output of the pump. A second pump control system includes a valve member selectively moveable to open and close a second fluid path. The pump output pressure is reduced when the second fluid path is open. A third pump control system includes a torque-limiting coupling limiting a maximum input torque to the pump.

In another configuration, a lubrication and shift system for a power transfer device includes an input shaft, a first output shaft, a second output shaft and a range shift system for drivingly coupling the first output shaft and the input shaft at one of two different speed ratios. A mode shift system selectively drivingly couples the input shaft and the second output shaft. A lubrication pumping system includes a pump providing pressurized fluid to a first fluid path and a valve member selectively moveable to open and close a second fluid path. The pump output pressure is reduced when the second fluid path is open. The pump includes a cover plate also being moveable to vary the output of the pump. The position of the valve member and the cover plate are varied by an actuator of one of the range shift and mode shift systems.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a fragmentary cross-sectional view of a fluid pump constructed in accordance with the teachings of the present disclosure and installed in an exemplary power transfer device;

FIG. 2 is an end view of the fluid pump;

FIG. 3 is a schematic representing an exemplary power transfer device including a lubrication and shift system of the present disclosure; and

FIG. 4 is a flow chart depicting a method of operating the lubrication and shift system.

Corresponding reference numerals indicate corresponding parts throughout the several views of the drawings.

### DETAILED DESCRIPTION

Example embodiments will now be described more fully with reference to the accompanying drawings.

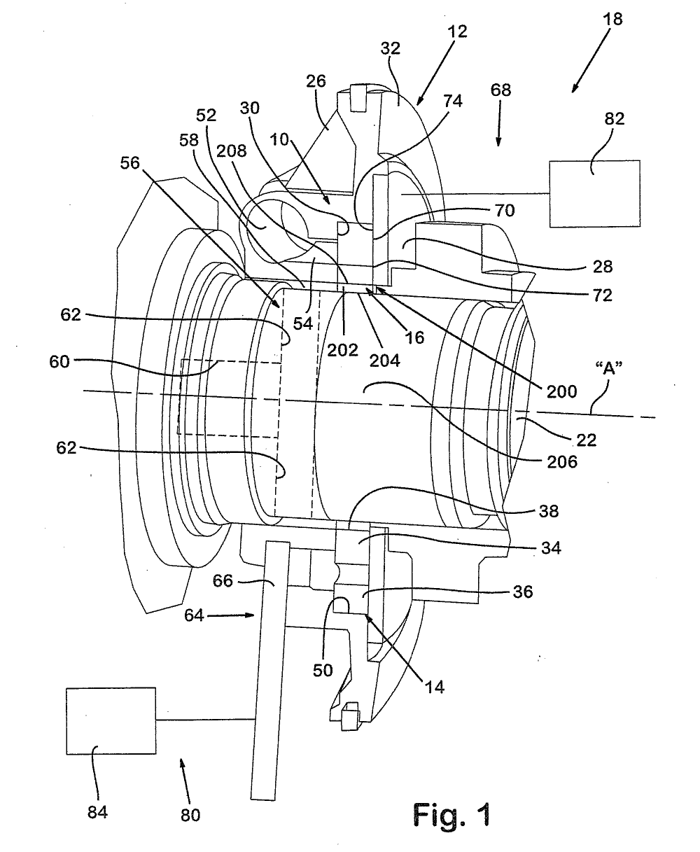

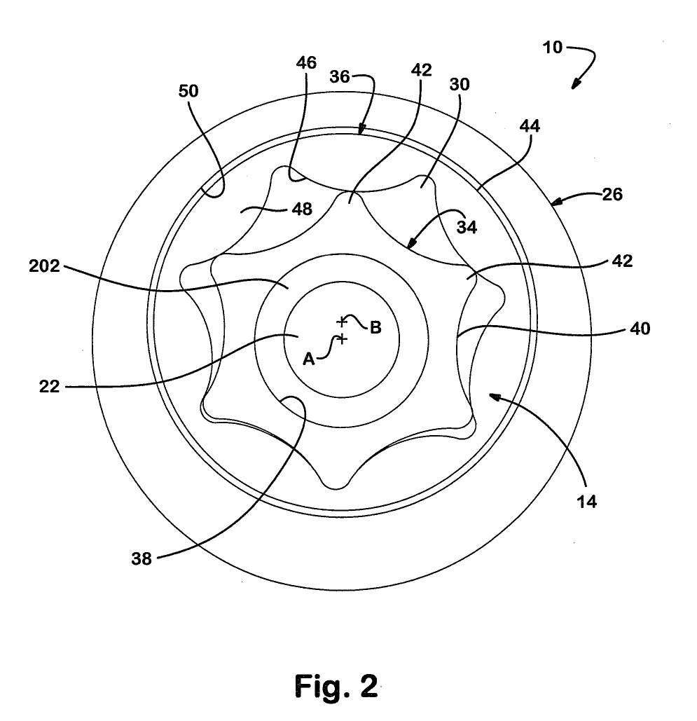

Referring primarily to FIGS. 1 and 2, the components of a torque-limited mechanically-driven fluid pump, hereafter referred to as gerotor pump 10, are shown. In general, gerotor pump 10 is contemplated for use in virtually any pump application requiring a supply of fluid to be delivered from a sump to a remote location for the purpose of lubricating and/or cooling rotary components. In general, gerotor pump 10 includes a pump housing assembly 12, a gerotor assembly 14 and a torque-limiting coupling mechanism 16. In the embodiment shown, gerotor pump 10 is installed within a power transmission unit 18 having a shaft 22 that is supported for rotation about a first rotary axis “A”. Pump housing assembly 12 is shown to include a pump housing 26 and an axially moveable cover plate 28 which together define a circular pump chamber 30 within which gerotor assembly 14 is operably disposed. The origin of circular pump chamber 30 is offset from rotary axis “A” of shaft 22, as shown by construction line “B” in FIG. 2. Pump housing 26 includes a flange 32 non-rotatably fixed to a portion of power transmission unit 18, not shown.

Gerotor assembly 14 includes an inner rotor (hereinafter referred to as pump ring 34) and an outer rotor (hereinafter referred to as stator ring 36) that are rotatably disposed in pump chamber 30. Pump ring 34 has a circular aperture defining an inner wall surface 38 that is coaxially disposed relative to shaft 22 for rotation about rotary axis “A” and a contoured outer peripheral wall surface 40 which defines a series of external lobes 42. Likewise, stator ring 36 includes a circular outer wall surface 44 and an inner peripheral wall surface 46 which defines a series of internal lobes 48. As seen, outer wall surface 44 of stator ring 36 is in sliding engagement with an inner wall surface 50 of pump chamber 30. In the embodiment shown, pump ring 34 has six external lobes 42 while stator ring 36 has seven internal lobes 48. Alternative numbers of external lobes 42 and internal lobes 48 can be employed to vary the pumping capacity of pump 10 as long as the number of internal lobes 48 is one greater than the number of external lobes 42.

Pump ring 34 is shown in FIG. 2 with its lobes 42 of outer peripheral surface 40 engaged with various points along inner peripheral wall surface 46 of stator ring 36 to define a series of pressure chambers therebetween. Upon rotation of pump ring 34 about rotary axis “A”, stator ring 36 is caused to rotate in pump chamber 30 about axis “B” at a reduced speed relative to the rotary speed of pump ring 34. Such relative and eccentric rotation causes a progressive reduction in the volume of the pressure chambers, thereby generating a pumping action such that fluid is drawn from the sump through an inlet tube (not shown). As best seen from FIG. 1, the inlet tube communicates with an inlet port 52 formed in pump housing 26 supplies fluid to an inlet chamber 54 that communicates with pump chamber 30. The pumping action caused by rotation between pump ring 34 and stator ring 36 within pump chamber 30 causes the fluid to ultimately be discharged into a first output flow path 56 including an annular outlet chamber 58 formed in pump housing 26 at the higher outlet pressure. Fluid discharged from outlet chamber 58 is delivered to a central lubrication passage 60 formed in shaft 22 via a plurality of radial supply bores 62. Central passage 60 communicates with various rotary elements located downstream of fluid pump 10 such as, for example, bearings, journal sleeves, speed gears and friction clutch packs via a series of radial lubrication and cooling delivery bores (not shown) also formed in shaft 22.

A second output flow path 64 is also provided with pressurized fluid from pump chamber 30. A valve member 66 is selectively moveable to open and close second output flow path 64.

In operation, fluid discharged from pump 10 due to rotation of shaft 22 is delivered to outlet chamber 58, radial supply bore 62 and central lubrication passage 60. Because pump 10 is a fixed displacement pump, output pressure from pump 10 increases as the rotational speed of shaft 22 increases. At some point, the output of pump 10 exceeds the lubrication and/or cooling needs of components associated with central lubrication passage 60. Accordingly, pump 10 draws more energy from shaft 22 than is necessarily required to provide adequate cooling and lubrication to the other transmission components.

The energy required to operate pump 10 may be decreased by coupling moveable cover plate 28 to a first pump control system 68 to vary the axial or face clearance between a surface 70 of stator ring 36, a surface 72 of pump ring 34 and a surface 74 of cover plate 28. As the face clearance increases, a viscous drag of the pump assembly will be reduced to reduce power consumption by pump 10. As would follow, pump output also decreases as the face clearance increases.

Another method for reducing the energy consumed by pump 10 includes coupling valve member 66 to a second pump control system 80 that may or may not cooperate with first pump control system 68. When valve member 66 is in the position shown in FIG. 1, second output flow path 64 is closed such that all of the output from pump 10 is provided to central lubrication passage 60 as previously discussed. When valve member 66 is moved to a second axial position, pressurized fluid from pump chamber 30 may flow through second output flow path 64. The restriction to fluid flow through second output flow path 64 is substantially less than the restriction to fluid flow through central lubrication passage 60. As such, the opening of the alternate flow path reduces the discharge pressure of pump 10, thereby reducing the power consumption of the pump. It should be appreciated that although the output pressure of pump 10 is reduced by bypassing central lubrication passage 60, lubrication fluid may still be directed to transmission components if necessary through alternate tubes and/or trough-like devices.

First pump control system 68 may include an actuator 82 such as a solenoid operable to translate cover plate 28 between a first position in engagement with pump housing 26 and a second position spaced apart from pump housing 26. Accordingly, the face clearance between cover plate 28 and pump ring 34 and stator ring 36 may be controlled by selective actuation of first pump control system 68. In similar fashion, second pump control system 80 may include an actuator 84 for translating valve member 66 between positions to selectively open and close second output flow path 64. Actuator 84 may include an electrically powered solenoid, a hydraulic piston or any other suitable force transferring mechanism to move valve member 66.

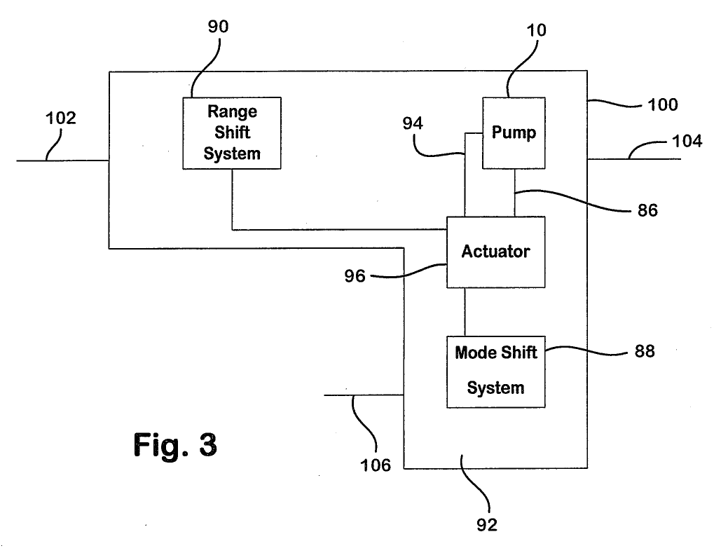

Alternatively, it is contemplated that first pump control system 68 includes a moveable member 86 having one end fixed to cover plate 28 and an opposite end drivingly coupled to a mode shift system 88 and/or a range shift system 90 of a power transfer device 92 such as a transfer case depicted in FIG. 3. In similar fashion, second pump control system 80 may include a separate moveable member 94 independently driven by one or both of range shift system 90 and mode shift system 88. In a different arrangement, member 86 and member 94 may be simultaneously driven by a common actuator 96. Further consolidation may allow actuator 96 to provide motive force for mode shift system 88, range shift system 90, member 86 and member 94.

Power transfer device 92 includes a housing 100 supporting an input shaft 102, a first output shaft 104 and a second output shaft 106 for rotation. Power transfer device 92 includes range shift system 90 for transferring power from input shaft 102 to first output shaft 104 in one of three ranges of operation. In the high range, torque is transferred from input shaft 102 to first output shaft 104 at a relatively high gear ratio such as 1:1. Range shift system 90 is operable to place power transfer device 92 in a low range of operation where torque is transferred from input shaft 102 to first output shaft 104 at a reduced speed and increased torque. Range shift system 90 may also interrupt the transfer of power between first output shaft 104 from input shaft 102 thereby placing power transfer device 92 in a neutral range.

Mode shift system 88 operates to selectively drivingly couple second output shaft 106 with input shaft 102. In this manner, output torque may be provided solely from input shaft 102 to first output shaft 104 or concurrently to both first output shaft 104 and second output shaft 106. Individual actuators or a common actuator may be utilized to operate range shift system 90 and mode shift system 88 in the manner previously described. Furthermore, it should be noted that actuators 82, actuator 84 of first pump control system 68 and second pump control system 80 may be eliminated by utilizing the actuator of range shift system 90 and/or mode shift system 88.

Referring once again primarily to FIG. 1, a third fluid pump control system 200 includes torque-limiting coupling mechanism 16 having a drag ring 202 that is operable for releasably coupling pump ring 34 for rotation with shaft 22 using a friction interface therebetween. Drag ring 202 includes an inner cylindrical surface 204 in biased engagement with an outer surface 206 of shaft 22. An outer cylindrical surface 208 is fixed for rotation with pump ring 34. The frictional interface between drag ring 202 and shaft 22 is operable to cause pump ring 34 to rotate with shaft 22 without slip therebetween until the torque transferred across torque-limiting coupling mechanism 16 exceeds a threshold value. Once this torque threshold value is exceeded, the torque required to drive pump 10 will exceed the torque limit of the drag ring frictional interface and cause it to slip, thereby causing relative rotation between shaft 22 and pump ring 34. Any number of other friction clutch arrangements may be used to provide the torque limited interconnection between shaft 22 and pump ring 34. Commonly owned U.S. Patent Application Publication No. US2006/0222552A1, hereby incorporated by reference, discloses other torque-limiting couplings that may form a part of pump 10 without departing from the scope of the present disclosure.

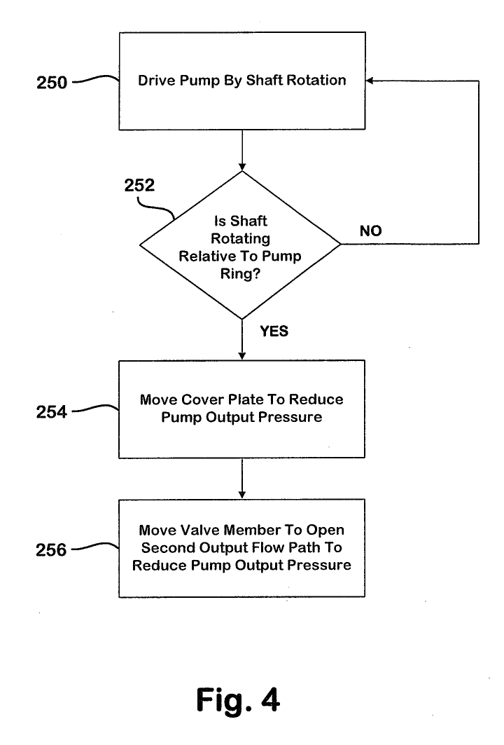

FIG. 4 depicts a flow chart for a method of operating pump 10. At block 250, pump ring 34 is driven by shaft 22 to cause pressurized fluid to begin to flow through central passage 60. Since most lubrication systems use fixed orifice delivery bores, an increase in the fluid pressure occurs in passage 60 as the flow rate through pump 10 increases. As previously mentioned, pump 10 is a fixed displacement pump having an output flow rate proportional to the rotational speed of shaft 22. At some point, the pressure in the pump system generates a torque on the pump ring 34 that equals the torque capacity of torque-limiting coupling mechanism 16. At this point, shaft 22 may continue to be driven at higher speeds, but pump ring 34 will rotate at a lower speed based on the fluid pressure in the system and the torque capacity of torque-limiting coupling mechanism 16.

While third pump control system 200 may function on its own to reduce the output of pump 10, the relative motion between drag ring 202 and shaft 22 generates heat and represents an energy loss. As such, decision block 252 determines if shaft 22 is rotating relative to pump ring 34. If so, one or more of the actuators is instructed to move cover plate 28 to reduce the output pressure of pump 10 at block 254. Depending on the configuration of the system, movement of cover plate 28 may concurrently occur with movement of valve member 66. In another system, valve member 66 may be independently controlled and moved to open second output flow path 64 at block 256 either before, after or simultaneously with the movement of cover plate 28. As previously described, the operations of blocks 254 and 256 will reduce the output from pump 10. As the output from pump 10 is reduced, the pressure within central passage 60 will also reduce. At some point, the reduction in pump output will reduce the resistance to rotating pump ring 34 such that the torque capacity of torque-limiting coupling mechanism 16 is no longer overcome. Pump ring 34 will rotate once again at the same speed as shaft 22. The combination of first pump control system 68, second pump control system 80 and third pump control system 200 drastically reduces the duty cycle on torque-limiting coupling mechanism 16 at the same time increasing the operating efficiency of pump 10.

The foregoing description of the embodiments has been provided for purposes of illustration and description. It is not intended to be exhaustive or to limit the invention. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the invention, and all such modifications are intended to be included within the scope of the invention.

What is claimed is:

1. A lubrication and shift system for a power transfer device, the system comprising:
an input shaft;
a first output shaft;
a second output shaft;
a range shift system for drivingly coupling the first output shaft and the input shaft at one of two different speed ratios;
a mode shift system for selectively drivingly coupling the input shaft and the second output shaft; and
a lubrication pumping system including a pump providing pressurized fluid to a first fluid path and a valve member selectively moveable to open and close a second fluid path, the pump output pressure being reduced when the second fluid path is open, the pump including a cover plate also being moveable to vary the output of the pump, the position of the valve member and the cover plate being varied by an actuator of one of the range shift and mode shift systems.

2. The system of claim 1 wherein the actuator controls movement of the range shift system, the mode shift system, the valve member and the cover plate.

3. The system of claim 2 wherein the actuator includes an electric motor.

4. The system of claim 1 wherein the pump includes a gerotor.

5. The system of claim 1 further including a torque-limiting coupling limiting a maximum input torque provided to the pump.

6. The system of claim 5 wherein the torque-limiting coupling includes a friction clutch including a drag ring fixed for rotation with a pump input member and biasedly engaged with one of the input shaft and the first and second output shafts, the drag ring slipping relative to the one shaft when a predetermined torque is exceeded.

7. The system of claim 6 wherein, during operation of the power transfer device, a drag ring slipping time is minimized by moving one of the valve member and the cover plate.

8. The system of claim 1 wherein the pump includes a driven member concentrically aligned for rotation with one of the input shaft and the first and second output shafts.

9. The system of claim 1 wherein the first fluid path extends longitudinally through one of the input shaft and the first and second output shafts.

10. A lubrication and shift system for a power transfer device, the system comprising:
an input shaft;
an output shaft driven by the input shaft; and
a lubrication pumping system including a pump being driven by the input shaft to provide pressurized fluid to a first fluid path, as well first, second and third pump control systems, the first pump control system including a cover plate being moveable to vary the output of the pump, the second pump control system including a valve member selectively moveable to open and close a second fluid path, the pump output pressure being reduced when the second fluid path is open, and the third pump control system including a torque-limiting coupling limiting a maximum input torque to the pump.

11. The system of claim 10 further including an actuator for moving the cover plate.

12. The system of claim 11 wherein the actuator also moves the valve member.

13. The system of claim 12 wherein the actuator includes an electric motor.

14. The system of claim 13 wherein the pump includes a gerotor.

15. The system of claim 14 wherein the torque-limiting coupling is a friction clutch.

16. The system of claim 10 further including a range shift system for drivingly coupling the input and output shafts at one of two different speed ratios.

17. The system of claim 16 further including an actuator for shifting between speed ratios of the range shift system and moving the valve member.

18. The system of claim 17 wherein the actuator also moves the cover plate.

19. The system of claim 18 wherein the actuator substantially simultaneously moves the cover plate and the valve member to positions to reduce the output of the pump.

20. The system of claim 10 wherein the pump includes a driven member encompassing one of the input shaft and the first and second output shafts.
